(19) United States
(12) Patent Application Publication
(10) Pub. No.: US 2015/0088480 A1
(43) Pub. Date: Mar. 26, 2015

(54) GENERAL-PURPOSE SIMULATION SYSTEM USING SOCIAL NETWORK INTERFACE

(71) Applicants: OKINAWA INSTITUTE OF SCIENCE AND TECHNOLOGY SCHOOL CORPORATION, Okinawa (JP); THE SYSTEMS BIOLOGY INSTITUTE, Tokyo (JP)

(72) Inventors: Yoshiyuki Asai, Okinawa (JP); Takeshi Abe, Okinawa (JP); Hiroaki Kitano, Okinawa (JP); Masao Okita, Osaka (JP); Samik Ghosh, Tokyo (JP); Yukiko Matsuoka, Tokyo (JP)

(73) Assignees: OKINAWA INSTITUTE OF SCIENCE AND TECHNOLOGY SCHOOL CORPORATION, Okinawa (JP); THE SYSTEMS BIOLOGY INSTITUTE, Tokyo (JP)

(21) Appl. No.: 14/402,932

(22) PCT Filed: Jul. 11, 2013
(86) PCT No.: PCT/JP2013/004290

§ 371 Date: Nov. 21, 2014

Related U.S. Application Data
(60) Provisional application No. 61/671,049, filed on Jul. 12, 2012.

(51) Int. Cl. H04L 29/08; G06F 17/50; G06F 17/30; H04L 12/18; G06F 9/48

(52) U.S. Cl. CPC H04L 67/10; H04L 12/1813; G06F 9/4843; G06F 17/30; G06F 17/5009
USPC 703/13

(57) ABSTRACT

A simulation system includes an interface component connected to a public or shared network that has less restrictive access than networks inside the firewall, generating a simulation job and registering the simulation job in a database, a job control component accessing said database to retrieve the simulation job and scheduling the simulation job for execution, and a simulation execution component receiving the simulation job from the job control component, creating executable codes for numerical and parallel computing algorithms and distributing computing processes to multiple computers to execute the simulation job.

### TECHNICAL FIELD

The present invention relates to a computer implemented simulation system available to a wide range of researchers.

### BACKGROUND ART

Researchers in various scientific or engineering fields often would like to discuss with colleagues modeling schemes and results of a new simulation model for scientific or engineering projects. Traditionally, these discussions are done separately. To have discussions with sharing models and simulation data, the researchers need to follow several steps. For example, these steps include: sharing a model that is under development with colleagues by email; commenting on it and revising the model; creating executable model off-line and performing a simulation in a local machine; and after the simulation, again sharing the simulation results with colleagues by e-mail or a file-sharing service for further discussion. If the number of colleagues is large, the process can be burdensome and time consuming.

Further, even if a researcher wishes to perform high performance simulation with parallel computing, the researcher is not always in the environment where high performance computers (HPCs) are available. For example, if an institute where the researcher belongs does not have HPCs, it is not easy for the researcher to gain access to HPCs. Or even if the institute has an HPC, if the researcher is outside of the firewall, the access is usually restricted. Simulators must be able to have a direct access to computing resources. Therefore, users need to install the simulators on the computing resources directly. Since HPCs typically limit the access from outside by firewalls, it is difficult or impossible for users to access to the simulators from outside of the firewalls.

Further, simulations of models are typically done by saving the executable binary code of the model in a local storage area of computing resources, such as a desktop machine or cluster machine, and by executing the binary code on that machine. A model developer needs to write program codes for algorithm of numerical computation as well as the scientific logic of the model. Hence, for researchers, it is difficult to concentrate only on building the scientifically essential logic of the modeling target phenomena.

Since the model size is getting larger recently, parallel computation for high-performance computing on such as cluster machines is required. In this case, it is necessary for a researcher to implement specific algorithms using MPI (Message Passing Interface) or some other technologies to parallelize the processes. It is a time consuming task to implement such a program with parallel computing algorithm, because it requires high-level programming techniques.

Moreover, the parallelization efficiency is dependent on the hardware configuration of the cluster machines. For example, if a program was tuned on cluster A, the same program may not be always effective on cluster B. Hence a researcher needs to spend more time for optimization of the program depending on the hardware, which is again not scientifically essential.

In case of a large simulation, usually a simulation performer wants to know the progress of the simulation. It would be helpful show the percentage of the simulation progress, or to show graphs of time series data of the simulated variables. To do this, the model developer would need to spend additional time to implement such tricks in the program.

In addition, it may be necessary to modify the value of variables during a simulation, or interrupt the simulation in its midway, depending on the outcome of the simulation. Implementation of these tasks is time consuming and imposes additional burden besides the scientific issue to researchers.

SBSI (http://www.sbsi.ed.ac.uk/index.html) provides simulation service using their HPC. However the system is not reachable from the outside of a firewall, and supports only SBML (System Biology Markup Language) format.

There exist several simulators receiving SBML and CellML formats files as input. None of them has a function to send data to Social Network Services or receive simulation models from Social Network or like services. Many of them are standalone simulators, so that users need to install them to the computing resources directly, thereby being subject to the similar problems as discussed above.

### SUMMARY OF INVENTION

### Technical Problem

Accordingly, the present invention is directed to a simulation system that substantially obviates one or more of the above-discussed and other problems due to limitations and disadvantages of the related art.

An object of the present invention is to provide a simulation system accessible by a wide range of researches with improved convenience.

### Solution to Problem

To achieve these and other advantages and in accordance with the purpose of the present invention, as embodied and broadly described, in one aspect, the present invention provides a simulation system, including an interface component implemented in one or more of computers, the interface component generating a simulation job and registering the simulation job in a database, at least a portion of the interface component being placed outside of a firewall and connected to a public or shared network that has less restrictive access than networks inside the firewall to receive a model for simulation from outside of the firewall; a job control component implemented in one or more of computers, the job control component accessing said database to retrieve the simulation job and scheduling the simulation job for execution; and a simulation execution component implemented in one or more of computers, the simulation execution component receiving the simulation job from the job control component, creating executable codes for numerical and parallel computing algorithms and distributing computing processes to multiple computers to execute the simulation job, wherein, the job control component receives simulation progress information from the simulation execution job, registers the simulation progress information in the database, and sends the simulation progress information to the interface component, wherein the simulation execution component sends the simulation progress information to the job control component, temporarily stores data created by the simulation job, and sends simulation results to the interface component, and wherein the interface component displays the simulation progress information and the simulation results on a website hosted by the interface component or sends messages to users to inform the users of the simulation progress information and the simulation results.

In another aspect, the present invention provides a simulation system having the above-referenced features, wherein the interface component is configured to receive a simulation model from a user located outside said firewall and generates the simulation job in accordance with the simulation model.

In another aspect, the present invention provides a simulation system having the above-referenced features, wherein the interface component is connected to a public network including a social networking host, and receives the simulation model submitted through a social network website hosted by the social networking host.

In another aspect, the present invention provides a simulation system having the above-referenced features, wherein the interface component is configured to receive a simulation model from any one or more of Facebook Group, circles of Google+, Google drive, Dropbox, and model databases published on the Internet.

In another aspect, the present invention provides a simulation system having the above-referenced features, wherein the simulation model is expressed in any one or more of SBML (System Biology Markup Language), CellML, and PHML (Physiological Hierarchy Markup Language).

In another aspect, the present invention provides a simulation system having the above-referenced features, wherein the interface component displays graphs of the simulation results on the website, and sends the simulation results to a social networking service to display the simulation results in a social network website.

In another aspect, the present invention provides a simulation system having the above-referenced features, wherein the job control component and the simulation execution component are implemented in the same set of one or more of the computer inside the firewall.

In another aspect, the present invention provides a simulation system having the above-referenced features and further comprising one or more of additional simulation execution components, wherein when a plurality of simulation jobs are handled, the job control components assign the simulation jobs to simulation execution components, respectively, and wherein in at least some of the simulation execution components, a plurality of computers are connected through a real-time communication network to perform distribute computing over the network to execute the simulation job.

In another aspect, the present invention provides a simulation system having the above-referenced features, wherein the real-time communication network is the Internet.

In another aspect, the present invention provides a simulation system having the above-referenced features, wherein said firewall is placed between the interface component and the job control component.

In another aspect, the present invention provides a simulation system that has the above-referenced features and that further includes a client computer connected to the interface component, the client computer being outside of the firewall and installed with a model building software to generate a model for simulation written in any one or combination of SBML (System Biology Markup Language), CellML, and PHML (Physiological Hierarchy Markup Language), the client computer submitting the model for simulation to the interface component.

### Advantageous Effects of Invention

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory, and are intended to provide further explanation of the invention as claimed.

### BRIEF DESCRIPTION OF DRAWINGS

FIG. 1 is a diagram schematically illustrating functional aspects of a simulation system according to an embodiment of the present invention.

FIG. 2 schematically illustrates the architecture of a simulation system according to an embodiment of the present invention.

FIG. 3 schematically illustrates an example of a physical configuration of a simulation system according to an embodiment of the present invention.

FIG. 4 is an example of a website interface screen according to an embodiment of the present invention.

FIG. 5 is an example of a website interface screen according to an embodiment of the present invention.

FIG. 6 is an example of a website interface screen according to an embodiment of the present invention, showing a simulation result.

FIG. 7 schematically illustrates a model building procedure in constructing a simulation model in an embodiment of the present invention.

FIG. 8 schematically shows examples of screen shots of a software program implementing the model building procedure in an embodiment of the present invention.

FIG. 9 schematically shows examples of a website interface in a simulation system according to an embodiment of the present invention.

FIG. 10 schematically illustrates an example of a physical configuration of a simulation system according to an embodiment of the present invention.

FIG. 11 schematically illustrates an example of the architecture of a simulation system according to an embodiment of the present invention.

### DESCRIPTION OF EMBODIMENTS

The present invention provides, in some embodiments, a procedure to seamlessly link the activities, such as scientific discussion, sharing models of physiological functions, performing simulations, and sharing simulation results, within a social community. It also relates to a method to run a high performance simulation ubiquitously.

In some embodiments of the present invention, the primary aspects of the system are the following.

1. Linkage between high performance simulation service provided in the internet and existing social network services (SNS), such as Facebook, Google+, or a propriety social network-type interface seamlessly.

2. The system architecture is suitable for being ported to or implemented in any type of high performance computers. The invented system receives model files written in languages, PHML (Physiological Hierarchy Markup Language), SBML and CellML. Information that is required for numerical computation, such as mathematical formulae representing the dynamics of the physiological phenomena, physical units, is described in the model file. However, the algorithms for numerical calculation and parallel computing, etc., need not be included, because the system handles all of these algorithms including automatic parallelization of processes.

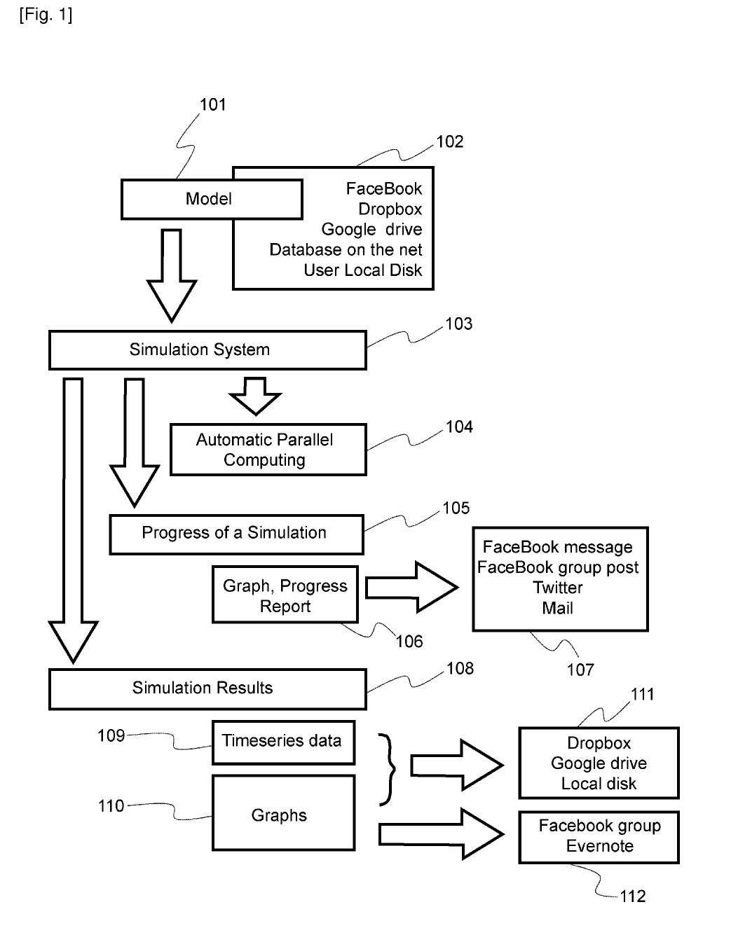

FIG. 1 is a diagram schematically illustrating functional aspects of a simulation system according to an embodiment of the present invention. The simulation system can receive models 101 through network directly from Facebook Group, circles of Google+, Google drive, Dropbox or model databases published on the net (such as physiome.jp) or from a proprietary social network-like interface (Box 102). Alternatively or in addition, an application can upload a model directly to the system using APIs (Application Programming Interface) provided by the system 103. By this feature, users can try a simulation of a model on which they discuss at a Facebook group or Google+ circle, for example, anytime.

The invented system automatically generates an executable code based on the inputted model file for a simulation. Algorithms to parallelize the processes are incorporated into the executable code automatically, and simulation is performed by parallel computation (Box 104).

Function and interface to change the values of parameters, abort the simulation, and to interrupt the simulation at any time during simulation are also implemented in the system. Users do not need to implement these functions.

The simulation results 108 are stored on the server at first. The progress report 105/106 (such as percentage of completion) is also generated automatically. The invented system notifies users the progress information by sending messages 107 via e-mail, Facebook message, Facebook Group post, Twitter, and Google+ message with a frequency that users defined.

Time series data generated by the simulation can be large in size. In such a case, time series data 109 and graph images 110 may be sent to storage media 111, such as user's local machine, Dropbox, and Google drive. Graph images may be sent to a Facebook group, a Google+ circle or Evernote 112 as well, so that users can continue to discuss based on the simulation result on the SNS (social network service) or on the proprietary social network type interface.

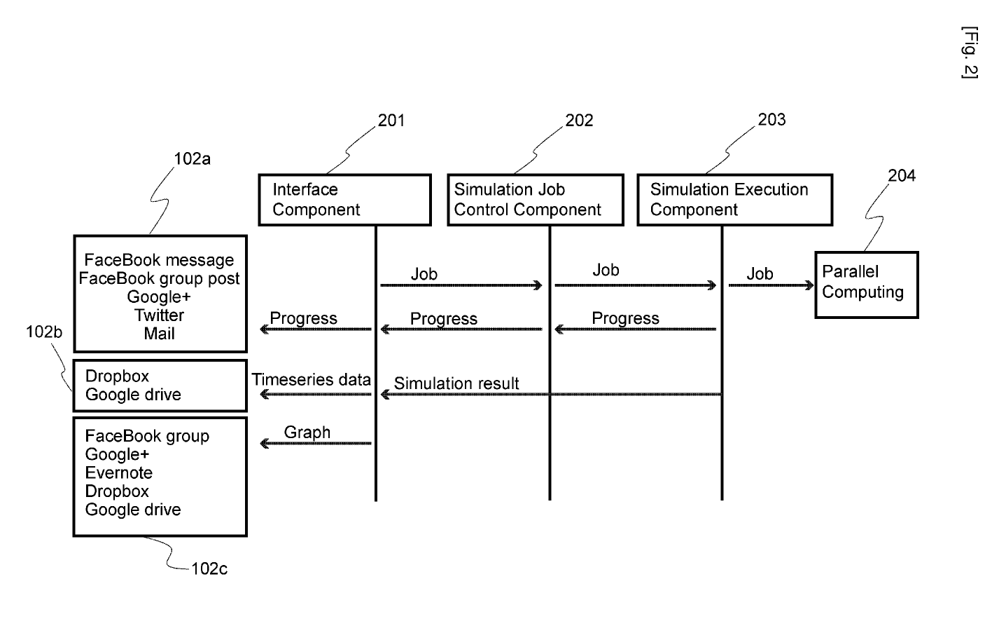

FIG. 2 schematically illustrates the architecture of a simulation system according to an embodiment of the present invention. In this embodiment, the simulation system includes an interface component 201, a simulation job control component 202, and a simulation execution component 203. Hereinafter a simulation job is simply referred to as a job.

The interface component 201 generates a job and registers the job to a database. The interface component does not directly send jobs to the job control component (although the arrow in FIG. 2 indicate a flow of “Job” from the interface component 201 to the job control component 202, the job is indirectly forwarded through the database), so that the interface component 201 can be located outside of the firewall surrounding the computing resources. The interface component 201 also receives the simulation progress information from the job control component 202, and displays the information on its website accessible by the browser or sends messages via e-mail, twitter, Facebook message, or Facebook group 102a, to inform users of the progress information. In addition, it displays graphs of simulation results on the website, and sends the simulation results to Facebook group, Google drive, Dropbox, Evernote, Google+ circle 102c.

The job control component 202 takes the job from the interface component 201 by accessing to the database. It also adjusts the timing to send the job to the simulation execution component 203, and sends the job to the simulation execution component 203 at the appropriate time. In addition, it receives the simulation progress information from the simulation execution component 203, and registers it in the database. Moreover, it sends the simulation progress and job status to the interface component 201.

The simulation execution component 203 receives a job from the job control component 202, creates executable code including parallel computing algorithms, and distributes the processes to multiple nodes, and executes a simulation automatically (Box 204). Moreover, it sends simulation progress information to the job control component 202. Data created by a simulation is stored in the simulation execution component 203 temporarily. After finishing the simulation, the result file is sent to users (102a to 102c), such as user's local machine, Dropbox, Google drive, via the interface component 201.

Because the system is composed of three components, as described above, the system can solve the problem on availability of the simulator system from outside of a firewall.

The simulation execution component 203 has direct access to computing resources such as PC clusters, since HPCs typically limit the access from outside by firewalls. As explained above, traditionally, a simulator was built as all-in-one single component application, and therefore, users needed to install the simulators on the computing resources directly. Also, it was difficult or impossible for users to access to simulators from outside of the firewalls.

However, because the system of the present embodiment is composed of three components, as explained above, it is possible to locate the interface component at DMZ (DeMilitarized Zone: a physical or logical sub-network that contains and exposes an organization's external services to a larger untrusted network, usually the Internet) so that a user can access the interface component from outside the firewall (the Internet), and can submit a simulation job to the system. Then, the job control component 202, which may be placed inside the firewall, can take the job from the interface component via TCP connection.

Furthermore, it is possible to perform a series of simulations by the simulation execution component 203. Moreover, because the job control component 202 can be installed in other places than computing resources, it is possible to operate the system more flexibly.

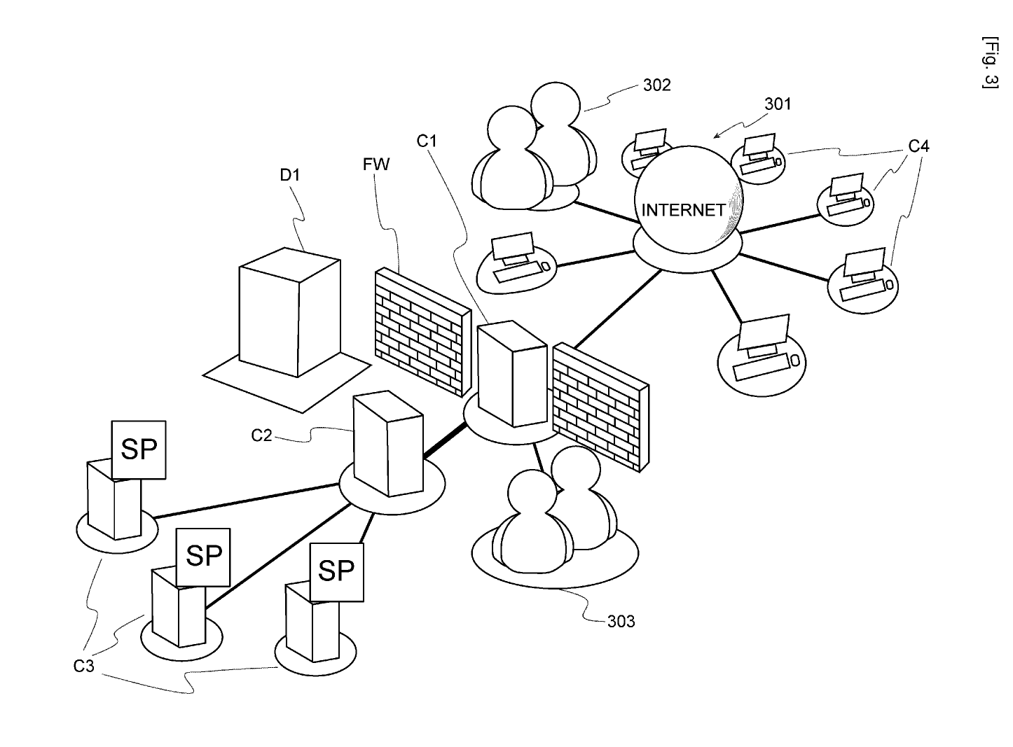

FIG. 3 schematically illustrates an example of a physical configuration of a simulation system according to an embodiment of the present invention. Computer C1 on a firewall FW represents the interface component 201, and computer C2 inside the firewall correspond to the job control component 202 and the simulation execution component 203. SPs indicate simulation processes distributed by the simulation execution component 203. As shown in FIG. 3, users 302 outside of the Firewall FW can use their local personal computers C4 to access the interface component (hosted by the computer C1) through the Internet 301. As discussed above, Social Networking Services (SNSs) or other like interfaces may be used via the Internet in submitting simulation models to the computer C1. With this configuration, not only users 303 inside of the firewall, but also users 302 outside of the firewall FW have access to computing resources. Here, D1 in FIG. 3 indicates the database in which the simulation job is stored as explained above.

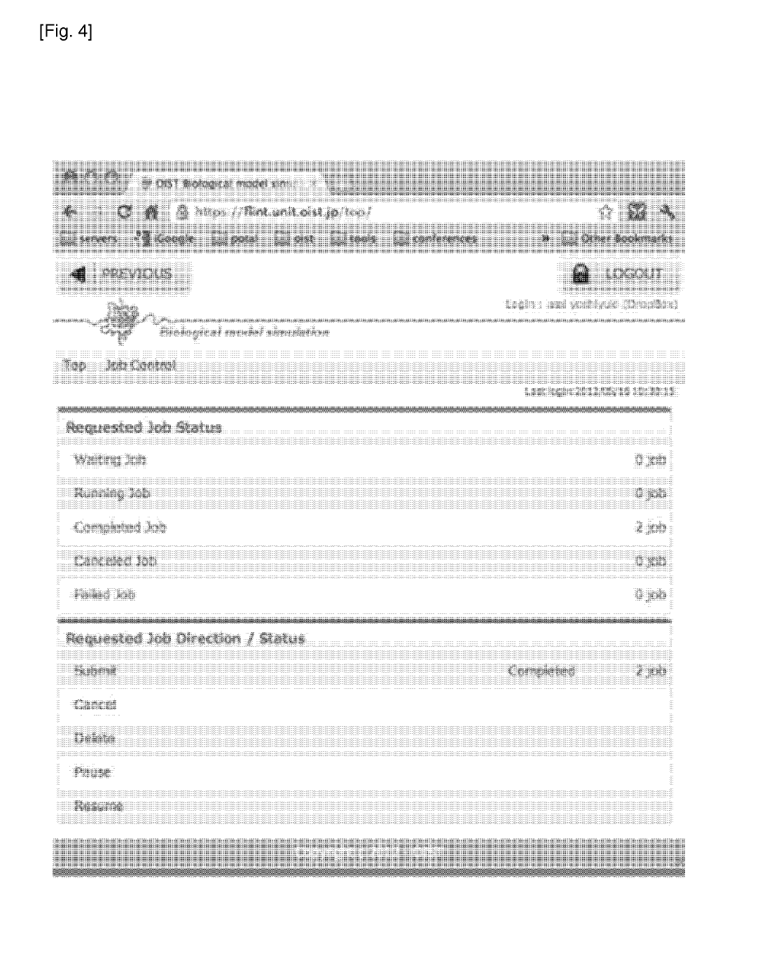

FIG. 4 is an example of a website interface screen according to an embodiment of the present invention. The computer C1 acting as the interface component 201 can host a website for authorized users and can receive and show information regarding the simulation. FIG. 4 shows an example of interface screen when the simulation is ongoing. As shown in FIG. 4, information and the status on requested simulation jobs may be glanced at once.

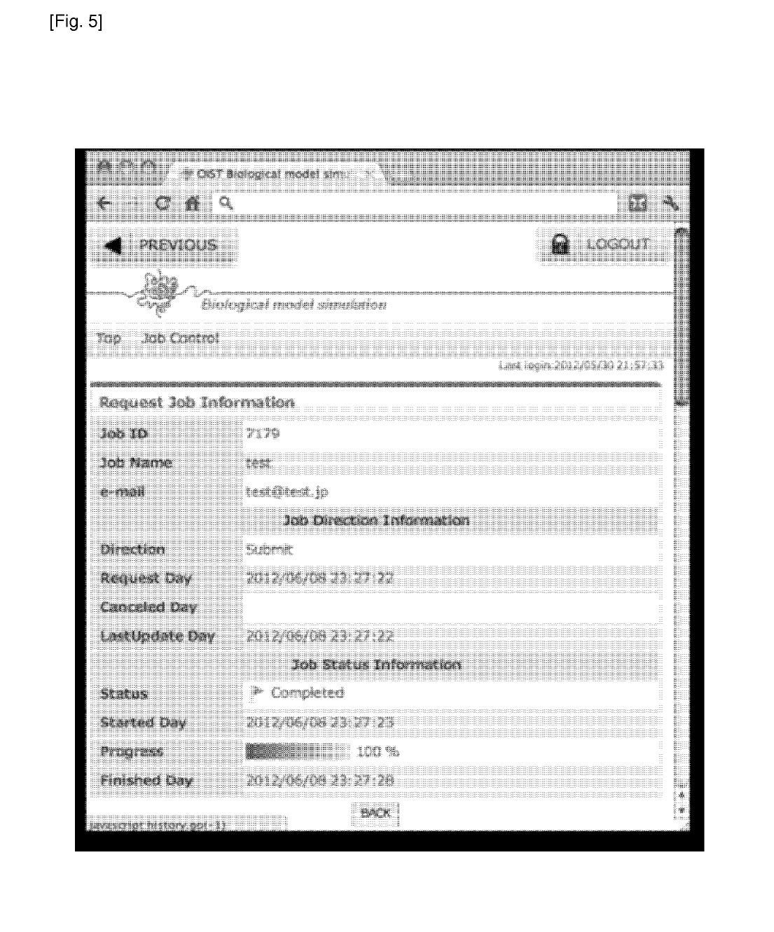

FIG. 5 shows an example of the website interface screen of the website when the simulation job is completed. The simulation status is now “Completed” and the progress bar shows 100%.

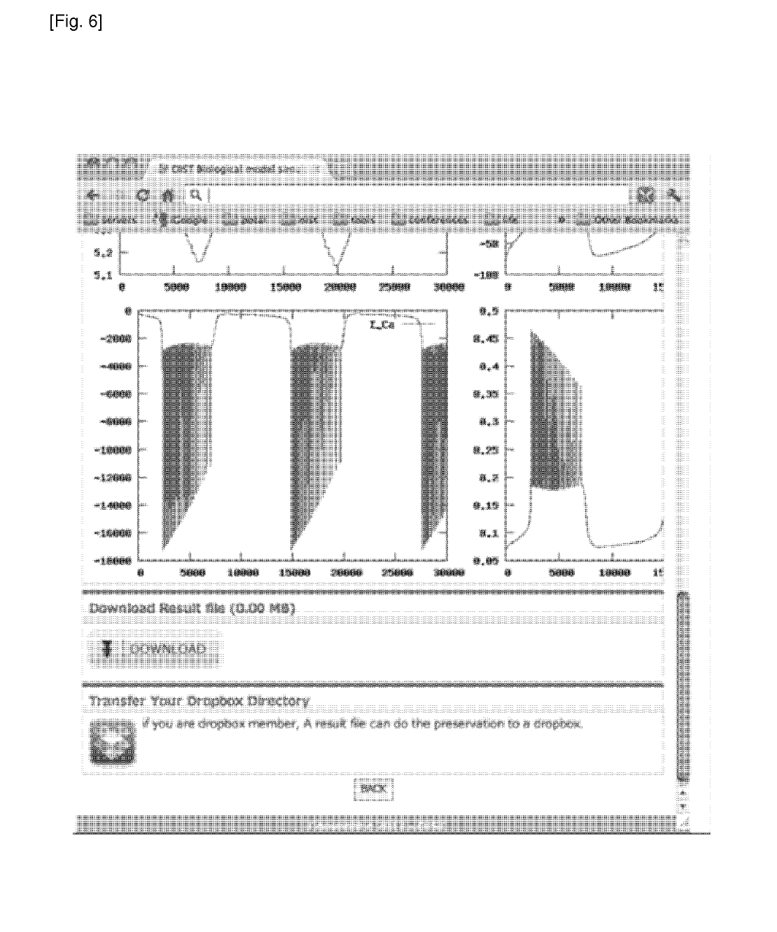

FIG. 6 is an example of the website interface screen showing the simulation results. As shown in this figure, the user can download the result to a local computer or can transfer the file to Dropbox.

As described above, in some embodiments, PHML can be used to build a model for the simulation. Since the conventional simulators do not support PHML for simulation models, the embodiments described above have significant advantage in supporting PHML.

Other embodiments of the present invention that are particularly suitable for biological or like researches are described below.

In this aspect, the present invention provides a software framework to support modeling and performing simulations of multilevel physiological systems, which, in some embodiments, has been developed and expanded to support the cloud computing.

The framework is composed of two blocks; a local model designer (an actually developed version is named “PhysioDesigner™”) and a simulation system implementing some or all of the features of the simulation system embodiments described above. An actually developed version of the second part-the simulation system-is named “Flint™” or “Flint system,” and its expanded version, which supports cloud computing, as described below, is named “Flint K3™ system.” PhysioDesigner™ is an application providing a graphical user interface for assisting users in multilevel modeling of physiological functions and a terminal interface for script-based model building. Models built on PhysioDesigner™ are written in PHML (the physiological hierarchy markup language). Flint™ is a standalone simulator, supporting MPI for parallel computing on a proper system environment. Based on the standalone application, Flint K3™ system supporting cloud computing has been developed, which provides a solution for portable high performance simulation. At the website of Flint K3™, users can upload models described in PHML. In addition, PhysioDesigner™ and other applications can submit simulation jobs to Flint K3™ directly at online.

Below, the background in developing these embodiments of the present invention and some of specific features of actually built application/systems: PhysioDesigner™, and Flint™, Flint K3™ will be described as embodiments of the present invention. However, the present invention is not limited to any of these specific features of the developed application/systems unless these features are recited in claims appended hereto.

In past decades, based on a large amount of data provided by the reductionism science, modeling-based science in systems biology and integrated physiology has been progressing rapidly. In these fields, models are getting bigger in size and more complicated and detailed in structure. It is almost impossible to build such models without inter-research-group collaborations, not only between so-called ‘wet’ and ‘dry’ research groups but also ‘dry’ and ‘dry’ research groups. For promoting effective collaboration, building large-scale models and performing CPU intensive simulations, it is very important to develop tools to support such activities.

Features described below, which are implemented in PhysioDesigner™, are aiming at providing a common integrated development environment for users who want to create models of multilevel physiological systems. Users can describe dynamics of a state of a targeted physiological system with hierarchically structured mathematical formulae using graphical user interface. The models built on PhysioDesigner™ are written in PHML (Physiological Hierarchy Markup Language), which is an XML based specification designed to represent explicitly physiological hierarchical functions. PhysioDesigner™ has been made available to the public (http://physiodesigner.org).

Besides the building models, performing simulations is the important counterpart. The simulation systems described above as embodiments of the present invention, which are implemented in Flint™, may be an interpreter type simulator that can work with PhysioDesigner™. As described above, the simulation system can be configured to parse PHML, compile internally and run a simulation. Flint™ can use multiple cores for computation-intensive simulations using MPI if the system has the MPI environment. This feature could be crucial because of the growth of the models in size. However, unfortunately, such high performance PC clusters with many CPUs are not always available. Flint K3™ service, which is Flint™ that can work on computer clouds has been developed to meet these needs. Flint K3™ system is equipped with a portal website for job managing. Users can submit simulation jobs on the site. Besides, PhysioDesigner™ can send a simulation jobs directly to the Flint K3™ via the Internet.

Model Building Software/System

A model building software is provided to assist users build models for simulations. PhysioDesigner™ is an application software that enables users to edit hierarchical multi-layer models of living systems. The application has been made available at http://physiodesigner.org. It has previously been developed as insilicoIDE (http://physiome.jp), and according to the recent progress in development, the application was renamed to PhysioDesigner™ as its next generation.

Embodiments of the present invention, if and when coupled with a model building software, may be configured to implement some or all of the features of the PhysioDesigner™, which will be described herein.

Models built on PhysioDesigner™ are written in PHML format, which is an XML based specification to describe hierarchy of systems in comprehensive biological models. PHML is a successor language of ISML (http://physiome.jp), which has been developed since 2007.

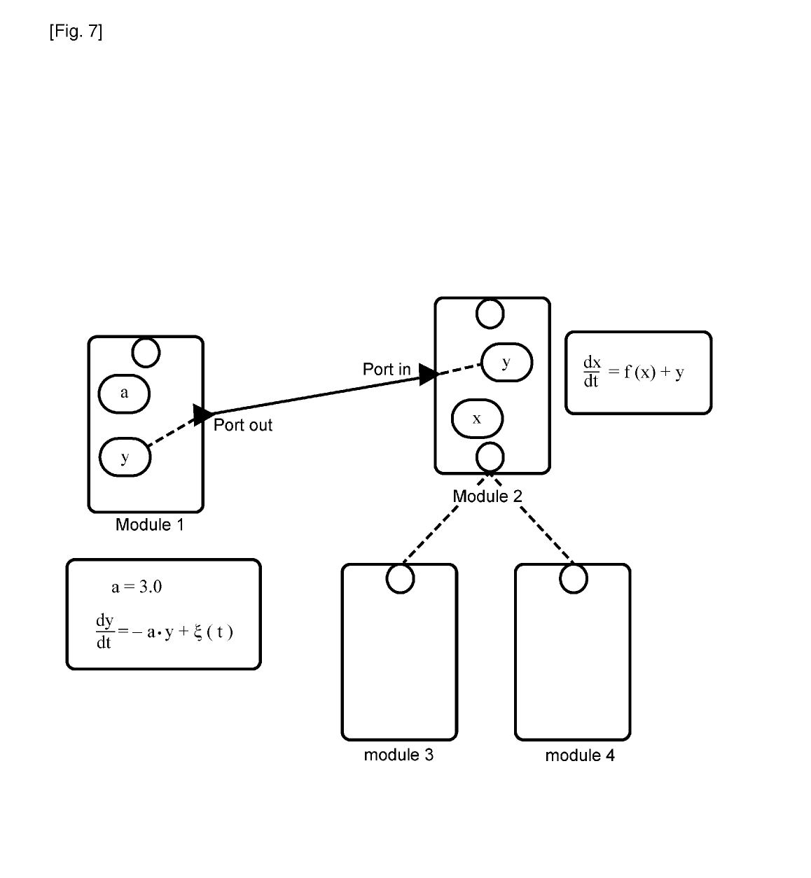

In PHML, each of biological and physiological elements involved in a model is called a module as summarized in FIG. 7, and structural and functional relationships among modules are defined by edges. Groups of modules can be defined as a module. By this recursive definition of the module, a hierarchical structure of the physiological systems is expressed in a model. Each module is quantitatively characterized by several physical quantities, such as, states defining the system's dynamics, and variable and static parameters. Definition of the dynamics such as ordinary/partial differential equations, or functions of physical quantities are explicitly described by mathematical equations.

Definition of a functional relationship among modules are represented by edges (functional edges) linking an out-port of a module to an in-port of another module, which carries numerical information defined as physical-quantities. A module receives the information can utilize it in equations defined in the module (FIG. 7).

Logical structures among modules can be also defined by edges (called structural edges). A logical structure represents a kind of ontology like relationships among modules such as “has a” relationship. In terms of physiology, it corresponds to “constitute” (e.g. many cardiomyocyte constitute a heart), “include” (a cell membrane includes organelles) and so on.

FIG. 7 shows an exemplary schema of PHML to represent modules, physical quantities, and edges. In Module1, there are two physical-quantities a and y are defined. a is a static parameter (i.e., constant) and y is a state used to define a ordinary differential equation. y is associated to an out-port to export its value, which is received by a physical quantity y in Module2 through a functional edge and an in-port. By this association between y in Module1 and y in Module2, the value of y defined in Module1 is used in the equation of x in Module2. Module3 and 4 are located at a sublayer of Module2.

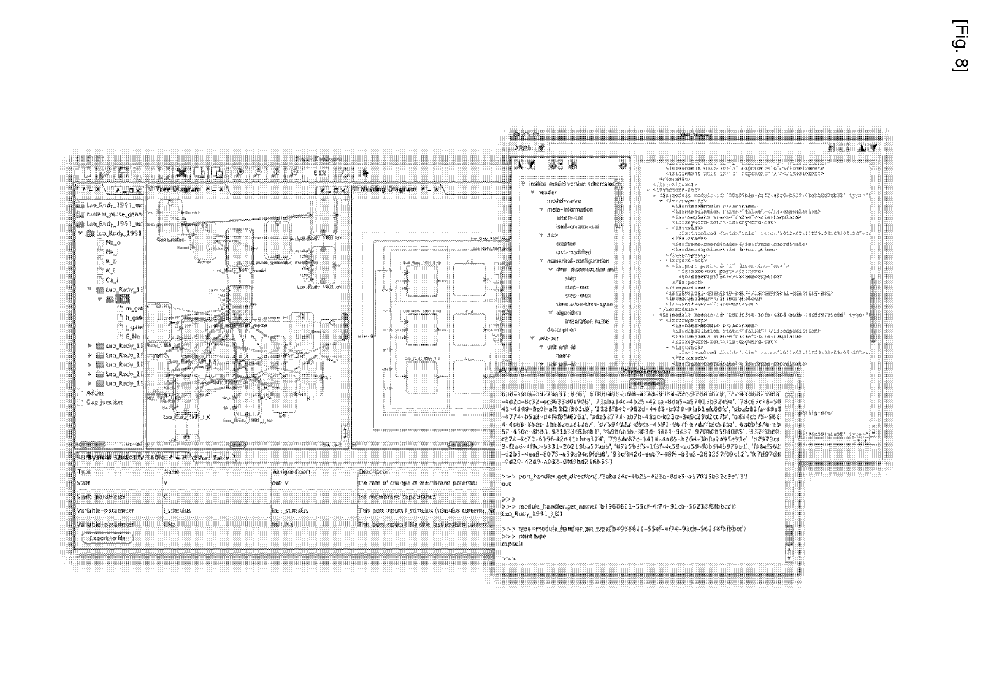

The application provides graphical user interface to set all configurations that can be described by PHML. See FIG. 8. FIG. 8 is a screen shot of some of the screens in the user display of the application. As schematically shown in FIG. 8, the application graphically shows a model in two ways. One is a tree diagram, and the other is a nesting diagram. The main window also contains tables of physical-quantities and ports of the selected module, and a component list of modules. In addition, there is a XML viewer and PhysioTerminal on which users can execute commands based on Python and PhysioDesigner™ APIs.

In addition, the application provides APIs (Application Programming Interfaces) written in Python. Using the APIs, a user can fully deal with models on a terminal (or console) with Python shell without using GUI.

In some embodiments, a multilevel modeling can be performed by SBML-PHML hybrid modeling. SBML (the systems biology markup language) is an XML format for computer models of biological processes, such as metabolism, cell signaling, and more. PHML is designed to represent a functional network and hierarchical structure using its modular representation. Combining SBML and PHML, it is possible to extend the capability to construct models including multiple levels of physiological phenomena. In some embodiments, there may be provided a functionality to import a whole SBML model in a module of PHML. Then the module can represent the sub-cellular phenomena that are modeled by the SBML model. By linking the module with the SBML model to other modules by functional and structural edges, the SBML model eventually can be embedded in a PHML module network effectively in the senses of both structural and functional relationships. There is an import section within a module section in PHML specification to describe a whole SBML model. Practically not only SBML but also any model format can be embedded in a module.

In SBML, there are “species” and “parameters” to represent quantitative attributes of biochemical entities. At a module including a SBML model, it is possible to define physical quantities associated to species or parameters to set or get numerical values. Physical quantities in PHML part can utilize the numerical information defined in the SBML model by “get” definition acting as an one-way bridge from the SBML part to the PHML part. Similarly but with opposite direction, “set” definition can quantitatively affect to the SBML part from PHML part by overriding the original definition of species or parameters in the SBML model without modifying the SBML model itself. By the definitions of getter and setter, the SBML model is effectively involved in the model.

Simulation Systems

In this disclosure, a simulation system implementing some or all of the features of the simulation system described above may be used in connection with the model building software described above. Some embodiments of the present invention may be configured to implement some or all of the features Flint™ and/or Flint™ system, described herein.

In the present invention, the tasks for model construction and for simulation are separated. Users can focus on the structure and logic for building a model without being troubled by implementation of algorithms for numerical calculations because these tasks are handled by the simulation system that receives models built by the model building software.

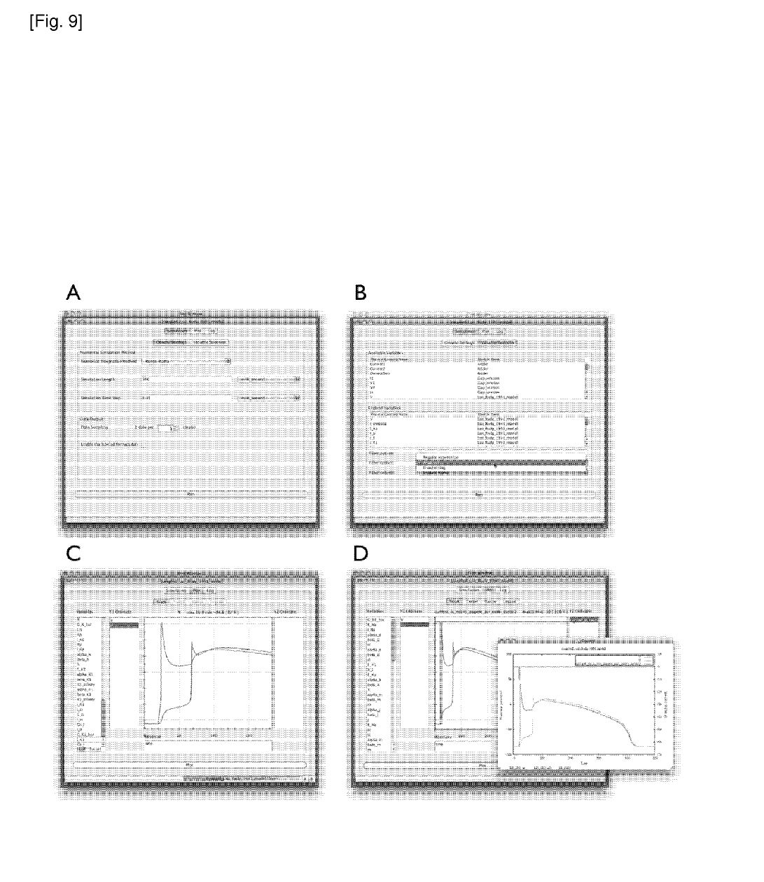

FIG. 9 shows exemplary screen shots of the user-interface on a webpage accessible by authorized users. On the top window of Flint™, users can select the numerical integration algorithm (for example, Euler method or 4-th order Runge-Kutta method), set the simulation duration, and time step with unit of time and sampling interval to record the values in a data file (A in FIG. 9). Before running a simulation, it is possible to select physical quantities that are recorded in the data file (B in FIG. 9). By these settings (sampling interval and selection of physical quantities), size of data file can be made smaller. C in FIG. 9 shows graphical outputs. Flint™ can show intermediate results by graphs during a simulation (C and D in FIG. 9). Graphs may be updated in substantially real time as the simulation progresses. This feature is convenient for users to check the current status of the simulation when they want to perform simulations that may take a long time. The graph plotter implemented on Flint™ can export the graph into an image files such as PDF, PNG, etc. Flint™ also supports external graph plotter such as gnuplot to create a more proper figure for publication or presentation.

The simulation system may be configured to perform simulations of models written in SBML as well as PHML using SOSlib. The system may be configured to parse and perform simulation of SBML-PHML hybrid models. This is an effective way to model and simulate models of spatiotemporal multi-level physiological systems as mentioned above. At first Flint™ extracts all equations and defines relationships among equations. Then it compiles internally those equations simultaneously. Flint™ can deal with equations with ODEs (Ordinary Differential Equations) and DDEs (Delay differential equations), which can include stochastic terms.

The simulation system may be configured to support parallel computing using MPI (for example, it has been implemented in Flint™ with OpenMPI 1.4 or later). The simulation system automatically divides a simulation over multiple CPUs (processors). This is one of advantages for users to use this platform, because if users want to adopt a parallel computing on a multi-core or PC-cluster environment, usually users are required to learn specific techniques additionally to develop a simulator which can perform parallel computing. This is usually a very time-consuming task.

For the development of cloud supporting feature of the simulation system of the embodiments of the present invention, a clear client-server architecture has been introduced to improve its portability.

In the case of Flint™, the server part is implemented as a program called “isbus.” A client software sends messages to isbus in order to request an execution of subprograms. Each of sub programs plays a specific role like parsing and inspecting a model, etc. Flint™ provides a GUI client implemented in Java. The same function may be implemented as a web application, as described below. When a client is going to run a simulation of a model, the client at first packs a request to start simulation of the model with parameters and sends it to dedicated TCP port of isbus. Then isbus reads the message, launches the program “isrun” which runs simulation processes for the model, packs a response and sends it back to the client. Notably packing messages is defined in a programming language in a neutral way, thus there are libraries of C++/Java/Python to handle the format. In the course of a simulation, simulation processes send the progress information to the client asynchronously. The client can either receive or ignore such information.

Simulation System with Cloud Computing

Since the size of models is getting larger and larger nowadays, simulation systems that work on high performance computers are demanded. To meet this demand, the simulation system that implement some or all of the features described above and that can work on cloud computing has been developed. The system so developed is named Flint K3™ (Knit Knowledge Knack) (referred to K3 sometime hereinafter). With this system, users of PhysioDesigner™ (or users in other model building environments) can immediately send simulation jobs to high performance cloud computing environment even if users do not have any accesses to high performance computers. K3 has been developed with “edubaseCloud” (http://edubase.jp/cloud), which is an open source based computer cloud for education of cloud engineering developed in National Institute of Informatics (NII). For development and preliminary test-run of Flint K3™, 64 cores on the cloud are assigned.

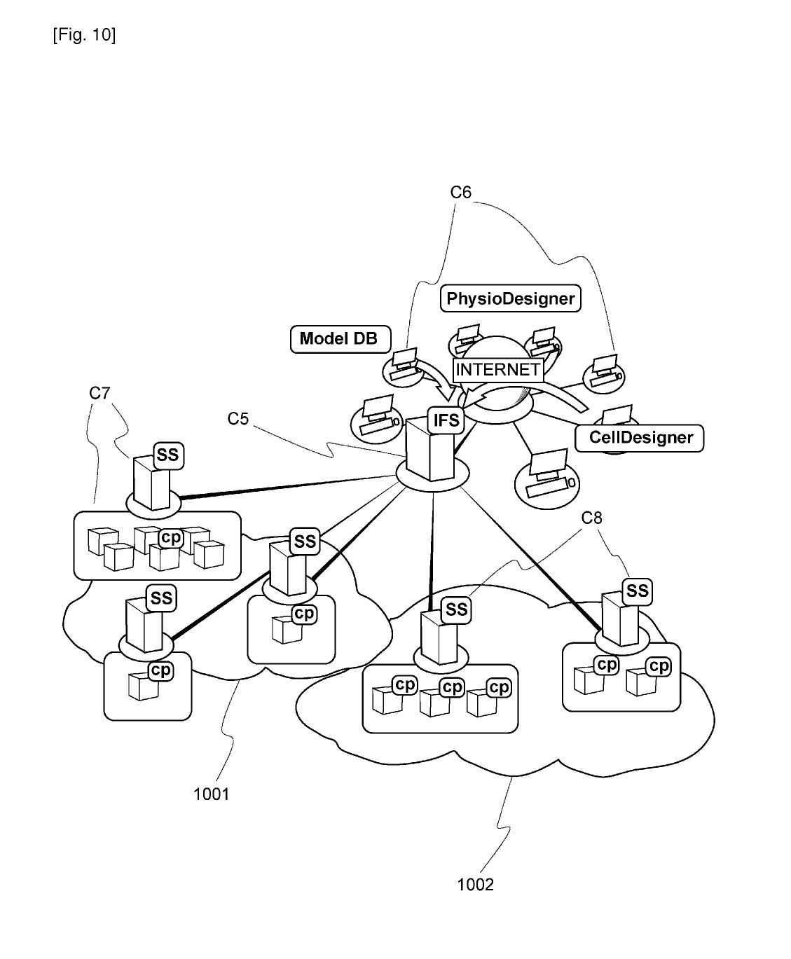

K3 is composed of two types of servers as shown in FIG. 10. One is an interface server (IFS), which receives job requests from users and manages the jobs, implemented in computer C5. Simulation jobs are sent from IFS to simulation servers (SS) implemented in respective computers C7 and C8 in the clouds 1001, 1002, respectively. SSs evoke a computation program (CP) in every node assigned for the simulation. CPs perform numerical computation of the model in parallel having communications among them.

In the architecture shown in FIG. 10, it seems that IFS may become a bottleneck of traffic. To avoid this issue, the traffic scalability may be ensured at IFS by several ways. One way is to put a kind of gateway on each cloud, so that the part of functions of IFS can be taken over by the gateways. Detailed communications are done between the gateway and SSs, and only necessary compact information is interchanged between IFS and the gateways. Alternatively or in addition, multiple clones of the IFS may be provided for the load balancing with a reverse proxy server. Then, the system can support secure single sign-on and distribute the loads to multiple IFSs at the same time.

In this embodiment, there are three ways for users to submit simulations jobs to Flint K3™. One way is to visit the K3 IFS on a web browser. Users can upload models and configure simulation parameters for submitting simulation jobs at the site by accessing the website hosted by the IFS through their respective computers C6 (FIG. 10). The second way is to utilize a linkage between K3 and Model databases at open domain (FIG. 10). Presently, there is PHML model database at Physiome.jp (http://www.physiome.jp/modeldb/index1.php) and SBML model database at several sites such as Payao database (http://celldesigner.org/payao/index.html) and BioModels in EMBL-EBI (http://www.ebi.ac.uk/biomodels-main/). Users can provide a model ID defined in each database to K3 IFS. Then K3 IFS accesses the database and downloads the model directly from the model database. Once such linkages among database and simulation server are built, users can easily check the dynamics of a model in database. The third way is to use the REST APIs implemented on IFS, such as simulate(model, parameters), getStatus(job-id) and getProgress(job-id) so that applications such as PhysioDesigner™ can access to K3 directly, for example, to submit a simulation job and get the progress report of simulations.

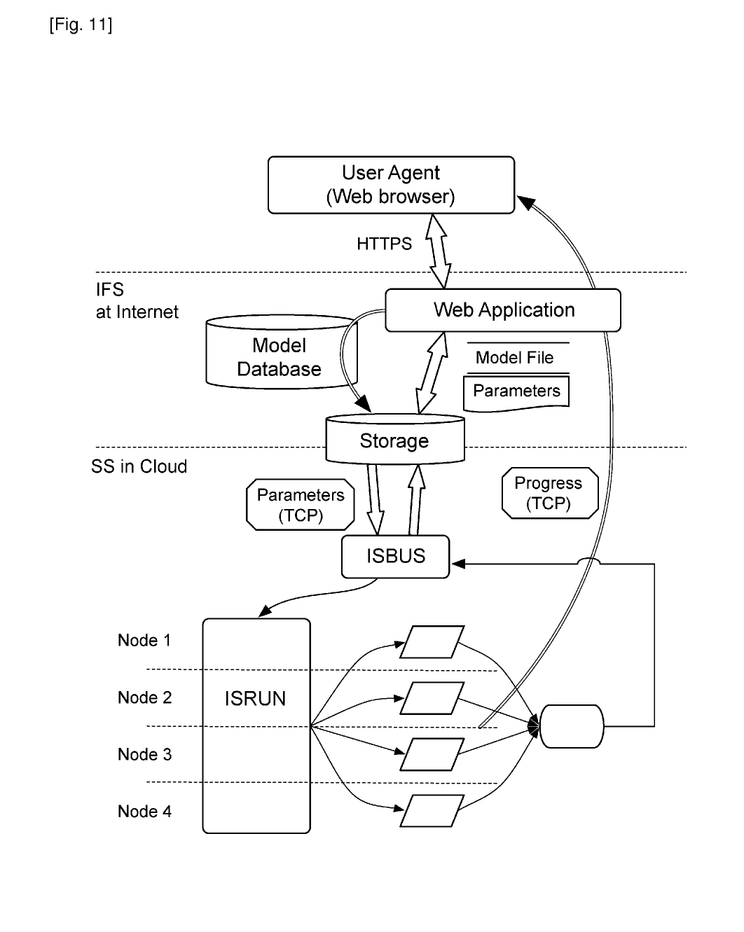

FIG. 11 shows a schema of internal architecture of Flint K3™ system. User agents access to the Web Application on the interface server (IFS), and job related information such as a model file and parameters are stored in a storage. ISBUS takes the job information from the storage, and send a signal to launch a simulation to ISRUN in the simulation server (SS) at a cloud. ISRUN evokes several processes for computation in multiple nodes in the cloud. Progress information of simulation is fed back to the user through the web application on IFS.

Basically Flint K3™ has the same architecture with the standalone version of Flint™, except the following three major differences. First, K3 is enhanced on security because a user has to be authenticated and authorized in a session. IFS utilizes the OAuth standard. Users can login to IFS using accounts on Facebook, Twitter, Google and Dropbox. Second, since K3 works in a cloud environment with a large number of machines, each of which has physical multiple cores, K3 should find a desirable MPI-based virtual machine configuration in terms of usage of cores. That is, it is possible to map a big simulation process to one fat virtual machine with many physical cores, as well as to map several small processes to several thin virtual machines with a few cores. Third, possibly long-living simulation jobs should be controlled with efficient scheduling.

As described above, in some embodiments of the present invention, a software framework for multilevel modeling and simulation is developed. The software framework is composed of PhysioDesigner™ as a model builder, PHML as a model descriptive language, and Flint™ as a simulator, aiming at accelerating the progress of the integrated physiology and systems biology. As an extension of a standalone Flint™ application, Flint K3™ system is developed with cloud compatibility for providing easy access to the high performance computing environment. The software framework can be implemented by multiple computers as described above.

Due to the composition of K3 shown in FIG. 10, it is possible to extend K3 to other clouds or computer clusters only by tuning simulation servers (SS in FIG. 10) to the new system's architecture for optimizing the performance.

There is yet another project called and Garuda platform, which aims at providing a fundamental technology to link software and knowledge in systems biology coherently. Flint™ and Flint K3™ services can be utilized not only from PhysioDesigner™, but also other tools which are in Garuda alliance (http://www.garuda-alliance.org/), such as CellDesigner. See FIG. 10. This expands the scope of Flint™ related technologies and other embodiments of the present invention among systems biology and integrated physiology.

As in the embodiments described with reference FIGS. 1-6 above, the IFS hosted by computer C5 (FIG. 10) may be constructed by three different components: an interface component, a job control component, and a simulation execution component, each of which may be implemented by one or more computers. One or more of firewalls can be placed at appropriate locations such as between the interface components and the job control component so that the IFS can be configured to interact with one or more social network services or like services available or developed in a public network, such as the Internet, or in a private or semi-private network to receive the simulation job through such services.

It will be apparent to those skilled in the art that various modification and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

### REFERENCE SIGNS LIST

103 Simulation System

201 Interface Component

202 Simulation Job Control Component

203 Simulation Execution Component

301 INTERNET

302, 303 Users

1001, 1002 Clouds

C1, C2, C3, C5, C7, C8 Computer

C4, C6 Local Personal Computers

D1 Database

FW Firewall

1. A simulation system, comprising:
an interface component implemented in one or more of computers, the interface component generating a simulation job and registering the simulation job in a database, at least a portion of the interface component being placed outside of a firewall and connected to a public or shared network that has less restrictive access than networks inside the firewall to receive a simulation model from outside of the firewall;
a job control component implemented in one or more of computers, the job control component accessing said database to retrieve the simulation job and scheduling the simulation job for execution; and
a simulation execution component implemented in one or more of computers, the simulation execution component receiving the simulation job from the job control component, creating executable codes for numerical and parallel computing algorithms and distributing computing processes to multiple computers to execute the simulation job,
wherein, the job control component receives simulation progress information from the simulation execution job, registers the simulation progress information in the database, and sends the simulation progress information to the interface component,
wherein the simulation execution component sends the simulation progress information to the job control component, temporarily stores data created by the simulation job, and sends simulation results to the interface component, and
wherein the interface component displays the simulation progress information and the simulation results on a website hosted by the interface component or sends messages to users to inform the users of the simulation progress information and the simulation results.

2. The simulation system according to claim 1, wherein the interface component is configured to receive a simulation model from a user located outside said firewall and generates the simulation job in accordance with the simulation model.

3. The simulation system according to claim 2, wherein the interface component is connected to a public network including a social networking host, and receives the simulation model submitted through a social network website hosted by the social networking host.

4. The simulation system according to claim 2, wherein the interface component is configured to receive a simulation model from any one or more of Facebook Group, circles of Google+, Google drive, Dropbox, and model databases published on the Internet.

5. The simulation system according to claim 2, wherein the simulation model is expressed in any one or more of SBML (System Biology Markup Language), CellML, and PHML (Physiological Hierarchy Markup Language).

6. The simulation system according to claim 1, wherein the interface component displays graphs of the simulation results on the website, and sends the simulation results to a social networking service to display the simulation results in a social network website.

7. The simulation system according to claim 1, wherein the job control component and the simulation execution component are implemented in the same set of one or more of the computer inside the firewall.

8. The simulation system according to claim 1, further comprising one or more of additional simulation execution components,
wherein when a plurality of simulation jobs are handled, the job control components assign the simulation jobs to simulation execution components, respectively, and
wherein in at least some of the simulation execution components, a plurality of computers are connected through a real-time communication network to perform distribute computing over the network to execute the simulation job.

9. The simulation system according to claim 8, wherein the real-time communication network is the Internet.

10. The simulation system according to claim 1, wherein said firewall is placed between the interface component and the job control component.

11. The simulation system according to claim 1, further comprising a client computer connected to the interface component, the client computer being outside of the firewall and installed with a model building software to generate a model for simulation written in any one or combination of SBML (System Biology Markup Language), CellML, and PHML (Physiological Hierarchy Markup Language), the client computer submitting the model for simulation to the interface component.
